(19) United States
(12) Patent Application Publication
(10) Pub. No.: US 2026/0203793 A1
(43) Pub. Date: Jul. 16, 2026

(54) SYSTEM AND METHOD FOR IMPROVED COMMERCIAL CONTENT BY WAY OF ARTIFICIAL INTELLIGENCE POWERED CREATION OF PERSONALIZED CONTEXTUAL COMMERCIAL CONTENT

(71) Applicant: John McDevitt, Clearwater, FL (US)

(72) Inventor: John McDevitt, Clearwater, FL (US)

(21) Appl. No.: 19/559,936

(22) Filed: Mar. 6, 2026

Related U.S. Application Data
(63) Continuation of application No. 18/593,857, filed on Mar. 1, 2024.
(60) Provisional application No. 63/488,508, filed on Mar. 5, 2023.

(51) Int. Cl. G06Q 30/0251

(52) U.S. Cl. CPC G06Q 30/0271

(57) ABSTRACT

A system and method that provides a process of utilizing artificial intelligence and user contextual information to create improved commercial content. Generally, commercial content is incongruent with the rest of entertainment content, acting as a distraction. Commercial content can be seen by a user as valuable if it is personalized and contextually relevant. Connected devices provide a great deal of information related to the user, their interests, and their environment. Artificial Intelligence (AI) enables rapid creation of content that can be tailored to a specific user efficiently, effectively, and inexpensively. The described system and method provides for the personalized creation of commercial content that is contextually relevant to the user through the use of AI.

### CROSS REFERENCE TO RELATED APPLICATION

This application claims priority to U.S. application Ser. No. 18/593,857, entitled System and Method for Improved Commercial Content by Way of Artificial Intelligence Powered Creation of Personalized Contextual Commercial Content, filed on Mar. 1, 2024, which claims priority to priority to U.S. Provisional Application No. 63/488,508, entitled System and Method for Improved Commercial Content by Way of Artificial Intelligence Powered Creation of Personalized Contextual Commercial Content, filed on Mar. 5, 2023, the contents of which are incorporated herein by reference into the present application.

### BACKGROUND OF THE INVENTION

Advertising, promotion, branding, marketing, commerce, sales, information, inspiration, education, and entertainment (collectively commercial content or content) is more effective when it is contextually relevant to the content consumer. It is not productive to try to sell dog food to a person that does not have a dog. The goal is to more efficiently, effectively, and inexpensively deliver meaningful content to the right user in the right place at the right time. The wrong content to the wrong person at the wrong time is at a minimum a waste of the marketing resources. Too often current marketing or commerce is inefficient and actually creates a negative experience for the user where the marketing is a distraction from the content, the user is actually interested in. Because environments or contexts are rapidly changing, and each person is a unique individual, it is difficult to be able to create and deliver meaningful commercial content to an individual user at a relevant time.

As people are almost constantly connected to the internet and very frequently consuming content of some type, there are an ever-growing number of places or moments that commerce content may be inserted into the media they are consuming. However, the commerce content to be inserted must be meaningful and contextually relevant to the individual user to yield positive results. Relying on existing technologies to create a vast number of pieces of creative content to properly reach the all the various users in the various contexts would be prohibitively expensive. However, Artificial Intelligence (AI) systems are rapidly evolving and offer the ability to dynamically create content that is personalized and contextually meaningful to individual users (or groups of users). The described invention provides a robust solution that enables the creation and delivery of user personalized content to the user's content consumption device that is contextually relevant in an efficient, effective, and inexpensively scalable way through the use of AI content creation.

### SUMMARY OF THE INVENTION

Accordingly, there is a need for a method and system that supports the efficient, effective, and inexpensively scalable creation of user personalized contextually meaningful or relevant commercial content. It should be noted that an entity (e.g., a company, corporation, partnership, country, group, individual, or the like) may want to have advertising, promotion, branding, marketing, commerce, sales, information, inspiration, education, or entertainment (collectively commercial content or content) for their viewers, customers, clients, consumers, or users. Thus, in the described example embodiment the terms entity, content, user, and similar terms are used as is generally understood by those skilled in the art. The term Artificial Intelligence (AI) is used as is generally understood by those skilled in the art. AI is a broad term and covers a variety of aspects, including but not limited to, narrow AI (reactive machine AI, limited memory AI (generative AI, autonomous systems)), general AI (theory of mind (emotion AI)), and super AI (self-aware AI). The AI may also utilize any of the following: computer vision, computer hearing, text vision, fuzzy logic, expert systems, machine learning, natural language processing, neural networks, stable diffusion, diffusion transformers, multimodal AI, Generative Adversarial Networks (GANs), Generative Pre-trained Transformers (GPTs), Variational Autoencoders (VAEs), Bidirectional Encoder Representations from Transformers (BERTs), neural radiance fields (NeRFs), or other similar AI approaches. Artificial Intelligence powered content creation is the main engine that enables the creation of Artificial Intelligence Content (AIC). The AIC includes, but is not limited to, a set or subset of, or collectively: preexisting real (real meaning non-AI created) content, preexisting AI created content, currently produced real content, currently produced AI created content, or a mixture of these. The nature of the content may be digital or digitized analog audio, digital or digitized analog video (just images, as well as, images and audio collectively), text, images, data, metadata, computer or AI generated content (including but not limited to related physics engines, logic engines, impossibility limiters, game dynamics, actual content that has been manipulated, purely fake content, computer code, pure data, etc.), Virtual Reality (VR) content, Augmented Reality (AR) content, Mixed Reality (MR) content, graphical overlays, visible and invisible data, all of the elements contained in the AIC, and any metadata that describes or is associated with or related to the attributes of the AIC, including but not limited to, creator (the creator may be human, machine, or a combination) associated with the content capture (capture may mean the capture as in taking a picture/video or the capture as in the creation by AI) device, content capture location data, content capture time data, capture device identification data, capture device inclination data (or similar X, Y, Z axis angle data), perspective or point of view data, capture device movement data, capture device altitude data (e.g., a drone), capture device orientation information, capture device camera data, capture device microphone data, contextual data, content element identification/description data, rights data, ownership data, license data, content labeling data, title data, description data, use data, preference data, trend data, transactional data, and other similar data related to the content and how/when/where it was captured, collectively or any set or subset of which is hereinafter referred to as content (or commercial content), Artificial Intelligence Content, or AIC. Furthermore, the AIC may be live (truly live or near live - delayed by processing, or distribution, or distance transmitted) or pre-recorded and the live content may be truly live, or originally live and re-presented, or a combination of these. Also, the AIC may be spontaneously generated or previously generated and displayed in real time (or a combination of both) as in the case of AI/computer-generated AIC, or VR/AR/MR AIC. Alternatively, the AIC could have never been presented live and is just previously recorded or previously created. The source content or library for the AIC may be created or captured by an individual amateur (person or system), a group of amateurs, by a professional (person or system), a group of professionals, an automated capture device systems, a computer/AI systems, or any combination of these. Any or all of the descriptive data or metadata about or contained in the AIC may be used to identify, organize, sort, structure, establish rules, verify compliance with rules, set distribution rules, or otherwise create or utilize the AIC in the AI Content Merge Engine (or later portions of the process). Additionally, any AIC may have an indicator added to it to designate it as AI or partially AI created content. AIC may have rules that ensure that the AIC conforms to any laws, regulations, or industry standards that would apply to any disclosure related to AIC. In general AIC is what is created by an AI Content Creation Engine or the AI Content Merge Engine.

Furthermore, in this invention, content and AIC (both source library input and AIC output) includes but is not limited to, each individually, or in any combination: audio (in any digital format, e.g., aa, flac, mp3, wav, wma, etc.), images (in any digital format, e.g., JPEG, TIFF, GIF, BMP, PNG, SVG, pdf, etc.), video (in any digital format, e.g., AV1, VP9, FLV, AVI, MOV, WMV, MPEG-4, MPEG-2, MPEG-5, HEVC, SD/HD/4K/8K/16K, etc.), LIDAR, text (in any digital format, e.g., txt, asc, etc.), video game content (in any digital format or language e.g., C++, Java, HTML5, CSS3, JavaScript, SQL, etc.), Computer Generated Imagery (CGI), Computer Generated Audio, Computer Generated Text, Computer Generated Video, AI generated content, Virtual Reality/Augmented Reality/Mixed Reality (VR/AR/MR), visible, invisible, thermal images, medical records, seismic data, gravitational data, electromagnetic, quantum data, IR, MRI, NMR, X-ray, UV, radio, or any other similar digital data in any digital format, and descriptive metadata related to or that describes any of the types of digital content. Additionally, the system can also begin with analog content which can be converted to digital content and then the process can proceed as if it started with digital content. Furthermore, the system may transcode between different formats to allow them to be harmonized and combined in a coherent way. Transcoding may occur more than once in the system to successfully create AIC.

The AIC can be created by way of utilizing the Target Content Framework and then with that as a seed or prompt combine existing content with AI created content (the resulting content may be all existing content, all AI created content, or a mix). The resulting AIC is aligned with the business rules and goals, the promotion rules, the user, and the context.

The AIC can be distributed toward consumer content consumption devices based on a set of Distribution Rules. The term rules is used generically (often in the simplest form being If-Then statements) these rule sets are often used in a coordinated way, taking into consideration goals and constraints, to arrive at desired final outcomes and may include one, some, or all sets of rules including, but not limited to, AIC rules (inclusions, exclusions, title, content, subject matter, capture device, capture individual, date of creation, timing of creation, location of creation, angle of creation, capture device movement, language, ownership, rights, duration, rating, geographic location, maximum length, minimum length, maximum number of results, minimum number of results, bit rate, AIC dimensions, format, historical view count, “likes”, reviews, date of consumption, rates of completion, etc.—including amongst other things any of the aspects of the AIC, AIC creator, or AIC distribution platform), business rules, individualized or grouped preferences, individual or grouped viewership/sales trends, and variable randomization methodologies may be in whole, partially, or individually utilized to decide which AIC set or subset to utilize in any given embodiment of the AIC. Furthermore, these rules may function as logical engines that may organize, prioritize, include, exclude, change the likelihood, etc. of a given individual AIC element (set or subset of an AIC element, or multiple AIC elements) to be used in the AIC. The rules may be set by an individual, group, a system, a computer, or a combination of any of these. The rules may be pre-established or dynamically established, or a combination of both. The AIC can be consumed on a user's content consumption device. Please note the terms “user”, “viewer”, “listener”, “individual”, and “consumer” are used interchangeably, generically, and could mean any creator/capturer of AIC or consumer of any of the AIC and the user could be a human individual, a group of humans, an animal or animals, another computer system, or set of systems. Additionally, the term “view” is used generically and can mean any method of consumption of the AIC (e.g., read, watch, listen to, play (in relation to games), interface with, or otherwise experience). For AIC sets to be different or unique they just have to be captured separately in terms of at least one of AIC AI content creation process, existing content included, real content library used, prompt used, consumer context, business rule or goal, promotion request, time, or location. Alternatively, if an AIC set is edited to be different from another AIC set it may be considered to be unique.

The resulting AIC may be distributed (transmitted) toward a user (directly or indirectly) by way of one or more of: wireless (e.g., 3G, 4G, 5G, etc.), wired, IP, Wi-Fi, Bluetooth, or similar two way communication technologies on any connected user content consumption device (e.g., a smartphone, tablet, personal computer, computer system, laptop, media streamer, smart TV, smart home speaker, game console, AR/VR/MR viewers, smart home appliance, a viewing device with a set-top box type processor, or the like, individually or in combination) that can support AIC playout. The AIC may be distributed as a complete discrete set, may be streamed continuously, or may be a combination of segments that are distributed in batches. The AIC may be as limited as a single bit of data or as large and long as multiple endless streams of audio, images, text, video, etc. Additionally, the disclosed system and method allows for the AIC to be played-out on a device that allows for two-way communication (in real time, near real time, or stored and forwarded) such that consumption or use data related to the AIC can be collected. This two-way communication allows in some cases for a set of user AIC playout devices to function as VR/AR/MR players and controllers in that when the playout device is moved in space the AIC adapts to the movement of one or more of the playout devices. Additional user behavior or actions may also provide contextual data for the AIC development. With the user's device monitoring things such as eye tracking movement, physiological responses (e.g., respiration, heart rate, pupil changes, skin galvanic changes), or neural feedback. Furthermore, the AIC rules may limit playout rights, including but not limited to, play / not play, only play certain sections, play specific MPAA (or similar) rated AIC material (e.g., G, PG, PG-13, R, NC-17, X, XXX), play with or without advertisements, play only if content is paid for, only play in certain geographic regions, play only on specific AIC distribution platforms, etc.. This collected use data may be analyzed and interpreted by a user or the larger system and provide data as the basis for a feedback loop that enables the system to dynamically learn and adjust the next generation of AIC creation and distribution. The AIC distribution platforms may include amongst others, YouTube, Twitch, Facebook, Instagram, TikTok, Twitter, Pinterest, Vimeo, Netflix, Roku, Google News Feed, Apple News Feed, Prime Video, etc.

Furthermore, it should be recognized that the resulting AIC may be a set of a wide variety of different content, including but not limited to, entertainment, education, information, marketing, promotion, commerce, gaming, training, therapy, inspiration, security analysis, police investigations, military strategy, emergency response, crowd analysis, medical data, health data, machine data, industrial data, VR/AR/MR, and the like. AIC does not have to be considered as only advertisements but may be any type of content, including content that advertisements or AIC advertisements may be placed in. The AIC may include real people, objects, locations, and the like. Additionally, the AIC may be dynamically (in real or near real time) created without or without predetermined storylines or endings. The AIC may be presented from the user's, a God's eye, third-party perspective, or combination of these. Similarly, the system may aggregate content from multiple perspectives and create holographic or near holographic AIC. These variety of perspectives is especially useful in gaming, training, and VR/AR/MR experiences—including those where the content is consumed on a headset. In alternative embodiments it may be the case where a single user may have multiple different AIC streams running simultaneously and the different AIC streams may be independent or may interact with each other Furthermore, it may be the case where there are multiple users with sets of AIC streams and some of those AIC streams may interact with those of other users in real time, near-real-time, or as recorded content (in some cases in a coordinated fashion).

The disclosed system provides for, in some cases, continuously or periodically changing and updating the AIC such that over time the AIC is different than the AIC that is initially created. These changes may be based on one or more of any relevant data such as additional individual AIC sets, user reactions, consumption rates, viewer reviews/feedback/“likes”, viewers paying for or subscription to AIC, sales performance (in commerce environments), likes, clicks, impressions, resulting subsequent behavior, and any other consumption related results (both from the individual viewer or from a plurality of users—including up to the full population of AIC consumers), and also external data sources (changes in laws, regulations, licenses, or rights related to the AIC, relevant related but external data, trends of other related content, historical or current media trends, product sales trends, news events, predicted trends, user behavior, etc.). The feedback loop may use various sets of information and machine learning/artificial intelligence (ML/AI) analysis to improve the user experience by creating improved AIC. The disclosed system may use ML/AI systems using traditional or quantum computing methodologies to aid in combining the individual. AIC sets, changing the rules or goals, and even creating new computer-generated AIC to better merge or fill gaps in the existing original individual AIC sets such that the AIC is optimized in accordance with the rules or goals engine. Furthermore, these ML/AI based approaches may be used specifically for improved interactive game play or VR/AR/MR experiences. Additionally, this system can be applied to recorded, live (or near live) AIC capture situations (e.g., as an event is occurring) and be applied to open-ended and non-predetermined storytelling (in which there are not pre-defined plots or endings to AIC sets, but rather they develop through use over time and can be applied to any type of AIC, including AIC that is created by the user (or sets of users)). This improvement process may be utilized for future AIC consumption or also even as the AIC is initially being consumed and the “end” of the AIC that has not yet been created (or even decided upon) and may be altered based on this dynamic learning methodology (or feedback loop) to improve the remaining AIC to be consumed. Furthermore, this information may be directed to those individuals or systems that are capturing or creating AIC such that they may adapt their capture or creation to the feedback information (a rapid and responsive feedback system).

In alternative embodiments, additional third-party Other AIC may be used and included in the AIC. By way of example, but not limitation, Other AIC is initially generated external to this process and incorporated into this process and could be computer generated AIC, ML/AI AIC (computer generated “fake” AIC or computer manipulated “real” content), URL's, links to other content (or AIC), advertising AIC, editorial AIC, instructional AIC, informational AIC, commercial AIC, entertainment AIC, game AIC, training AIC, or other alternative AIC. Furthermore, in all cases the AIC can contain any mix of created AIC, and Other AIC (or any mix of any set or subset of data in any of the AIC sets). This Other AIC may be incorporated into the AIC unchanged, completely changed, or a combination of these.

In relation to this disclosed invention, context refers to the user themselves and the environment the user of the content was previously in, currently is in, or expected to be in (e.g., the user is on a train and the train has passed stations 1, 2, & 3, is currently at station 4, but will soon move on to stations 5, 6, & 7). This is a broad idea and may cover things, including but not limited to, user identity, prior, current, or expected future content consumed, search behavior, physical location, interests, activities, content consumed, consumption device, purchase behavior, related devices, adjacent devices, etc. Often many of these elements may be linked or coordinated with similar items that are described in the content metadata (including but not limited to, creator associated with the content capture device, content capture location data, content capture time data, capture device identification data, capture device inclination data (or similar X, Y, Z axis angle data), capture device movement data, capture device altitude data (e.g., a drone), capture device orientation information, capture device camera data, capture device microphone data, contextual data, content element identification/description data, rights data, ownership data, license data, content labeling data, title data, description data, use data, preference data, trend data, transactional data, and other similar data related to the content and how/when/where it was captured). Other context data capture methods may be used such as audio, visual, or data fingerprinting matching captured context data against an existing library to better identify context. As an example, but not limitation, user or content data and metadata that may be collected and reported by a mobile phone. Additionally, context can also apply to the user content consumption device along with what, where, when, why, and how the user (or users) consume the content.

The disclosed system may be configured to utilize a set of AIC Distribution Rules to manage and govern the distribution (transmission) of the AIC. Please note there is not necessarily only one version of the AIC, there may be multiple sets of AIC at any given time and the make-up of those sets may change over time as governed by the AIC Business Goals and Rules set and the rules may be applied at the population, set, subset, or individual level of either (or both) of the AIC and viewer. The AIC sets can grow and branch over time developing linear and non-linear “story lines.” Additionally, the AIC Business Goals and Rules set may take into consideration items such as, but not limited to, the elements within the AIC, promotion requests, distribution rules, content consumption device rules, platform rules, intellectual property rights of the AIC, subscription rights to the AIC, the network(s) the AIC is distributed towards, over, through (e.g., unlimited home Wi-Fi or pay per bit delivered mobile networks, high bandwidth networks or low bandwidth networks, etc.), or the technical ability of the playout device (e.g., a speaker alone versus a HD/4K/8K television versus a VR/AR/MR headset, versus a smart phone).

As described herein, the disclosed system for creating personalized contextual content that is relevant to a user by way of the utilization of AI includes a collection of communicatively coupled components that support the transmission of data and interact in a coordinated fashion in a variety of sequences, synchronously or asynchronously. The system comprises, a processor communicatively coupled to one or more databases and the processor is configured to perform a series of steps in the described process, including but not limited to, analyzing the set of context data related to a content user, transmitting a set of analyzed user context data towards a database, accessing data stored in a database that contains a set of promotion or other content requests, accessing data stored in a database that contains a set business rules or goals related to the content set to be created, accessing user related contextual data stored in a database, accessing a library of existing content, utilizing an artificial intelligence processor to create a set of user personalized content by applying a set of business rules or goals and a set of user contextual data, merging or combining a portion of the set of artificial intelligence created content (which may be none) and the set of existing content (which may be none), accessing data stored in a database that contains a set of distribution rules related the user personalized content and the set of user content consumption devices, utilizing a processor to distribute the set of user personalized content towards at least one content consumption device of the user, in compliance with the set of distribution rules, utilizing a processor to analyze the performance of the set of AIC content to evaluate the AIC's performance relative to the rules or goals, and providing a feedback mechanism to further improve the process going forward. The user personalized contextual content that is created by way of AI with associated rules, goals, user, and contextual data may contain amongst other things, video, audio, images, text, or metadata, individually, collectively or any set or subset of these.

The method disclosed herein for creating user personalized contextual content by way of the use of AI includes a collection of communicatively coupled components that act in a coordinated fashion, synchronously or asynchronously. The described invention applies artificial intelligence to create a content set that is personalized to a user and relevant given the user's context. The method comprises: at least one processor communicatively coupled to at least one database, the accessing a set of promotions or other content that a brand desires to communicate to a user, the accessing a set of rules or goals related to a user personalized content set, the accessing of contextual user data stored in a database, utilizing artificial intelligence to create a set of user personalized content by combining a set of existing content from library, a set of rules or goals, and a set of contextual user data, the accessing of a set of user personalized content distribution rules stored in a database, the transmitting of a set of user personalized content towards a user's content consumption device (or devices), in accordance with the set of rules or goals, the assessing of a set of data related to the performance of the user personalized content relative to the rules or goals, and utilizing a feedback process to apply the set of performance data in further improving the entire process. Furthermore, the method of producing personalized contextual content that is created by way of AI with associated rules, goals, user, and contextual data may contain amongst other things, video, audio, images, text, or metadata, individually, collectively or any set or subset of these. In general, the described method may follow the following process: A brand desires to promote their product or brand. Then a set of rules or goals are established related to the content that would be used to promote the brand (these rules and goals may also include who the user may be—in general or specifically). A set of contextual data related to the user may be ingested (it may be at this point the user is selected to receive the promotional content based on the user's contextual data). The promotional content is created based on the rules and goals along with the contextual data using AI. This AI creation process may use existing real content, new real content, existing AI content, or new AI created content or a combination of these. There is a set of rules for the distribution of the AIC, including but not limited to, the target user, the time of distribution, the place of distribution, the method of distribution, the user's content consumption device, etc. The results of the distribution of the AIC is analyzed and those results are fed back into the method to improve the process.

### BRIEF DESCRIPTION OF THE DRAWINGS

FIG. 1 illustrates a block diagram of a system for creating personalized contextual content in accordance with an exemplary embodiment.

FIG. 2 illustrates a flowchart for a method of creating and evaluating personalized contextual content in accordance with an exemplary embodiment.

FIG. 3 illustrates an example of a general-purpose computer system in accordance with an exemplary embodiment.

### DETAILED DESCRIPTION

The following detailed description outlines possible embodiments of the proposed system and method disclosed herein for exemplary purposes. The system and method disclosed are in no way meant to be limited to any specific combination of hardware and software. As will be described below, the system and method disclosed herein relate to the creation, distribution, and analysis of AIC to achieve a set of goals in accordance with a set of rules. It should be appreciated that each of the components in the figures below are illustrated as simple block diagrams and flowcharts, but include the requisite commercial, mechanical, physical, digital, hardware, and software components needed to perform the specified functions as would be appreciated by one skilled in the art. For example, one or more of the components described below can support the transmission of data between the components and include one or more databases, one or more computer processor units (CPUs) configured to execute software programs stored on electronic memory in order to execute the algorithms disclosed herein, these databases and CPUs may be located together or apart, physical or virtual, and may be classical (traditional), quantum, momentum, or a combination of these types of computer processors. In general, the terms computer or engine can refer to classical (traditional) computing, quantum computing, momentum computing, artificial intelligence, machine learning, and any combination or set or subset of these, and these approaches may be applied synchronously or asynchronously, sequentially or in parallel (or a combination of these) and amongst other things may function as rules or operations engines in performing the various tasks herein. All the components are communicatively coupled with data transmission between the components enabling them to work in a coherent and coordinated way in a variety of sequences, in the complete process, or a portion of the process.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system and method for purposes of illustration only. One skilled in the art will readily recognize from the description that alternative embodiments of the systems and methods illustrated herein may be employed without departing from the principles described herein.

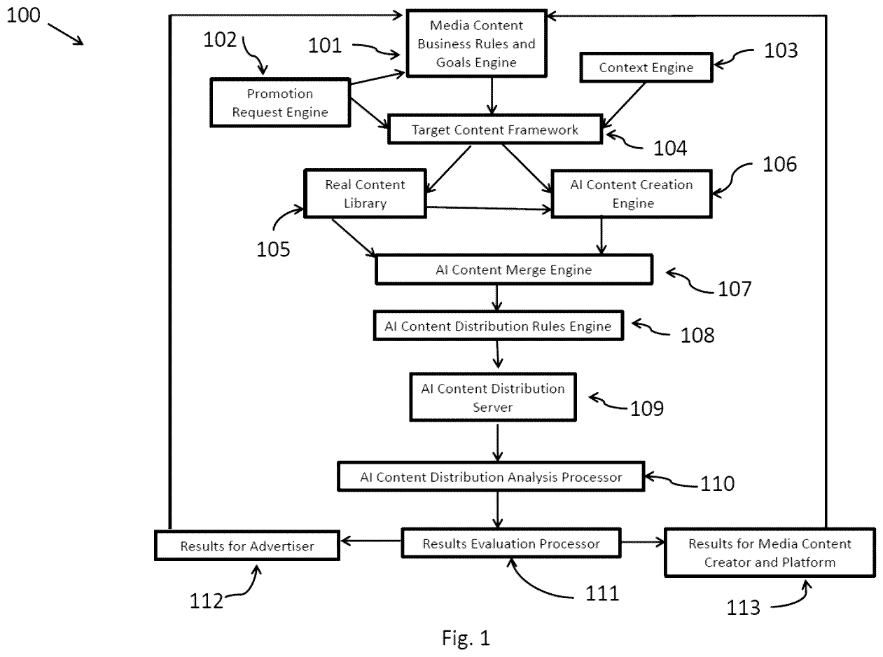

For example, but not limitation, FIG. 1 is a basic exemplary example of the AIC personalized contextual content creation system. It should be noted that each of the following functional activities of the system may be performed systematically and automatically with or without user intervention, or each may also be performed with a user override at any point in the process. Additionally, the rules or goals of this AIC personalized content creation system (100) may be pre-set or may be dynamically adapted in real-time or near real-time (continuously or periodically), and the adaptations may be based on the information that is available at that time, and also as additional information becomes available the rules or goals may be further dynamically (continuously or periodically) adapted. Furthermore, the goals or rules of this system (100) may be updated or adapted periodically or continuously based on pull or push commands internal or external to the system. These changes may be based on either or a combination of user /AI/ML input and will be described in more detail below. Additionally, the entire process may occur with multiple sets of AIC and the steps may be nested with different sets of AIC being processed at separate times, synchronously or asynchronously. Also, the various steps may occur in the original sequence, in alternative sequences, in parallel, or may even skip steps in various embodiments, especially when the process (or portions of the process) is run multiple times.

The Media Content Business Rules and Goals Engine (101) may cover a wide variety of things including, by way of example, but not limitation: rules or goals related to the AIC itself, the AIC content, the target user of the AIC, the required contextual elements, goals of maximizations or minimizations of elements, the platforms the AIC is consumed on, the user's content consumption device, the number of times the AIC is consumed, the total duration of time AIC is consumed, the average duration AIC is consumed, the total revenue driven by the AIC, the total number of clicks driven by the AIC, the revenue per minute of the AIC consumed, the revenue per view of the AIC, the clicks minute of the AIC consumed, the clicks per view of AIC, the total number new viewers driven by the AIC, the number of new viewers per minute of AIC consumed, the number of new viewers per view of AIC, the editorial quality (e.g., critically acclaimed nature or general viewer likes/stars/reviews) of the AIC, the profitability to the brand, creator or the platform of the AIC, intellectual property restrictions or requirements, nature of licenses, date of creation, geographic source, maximum content set length, minimum content set length, maximum number of content items (e.g., a series), minimum number of content items, quality of media content, business rules, legal requirements, ethical considerations, individualized or grouped preferences, number or rate of plays, number or rate of do not play selections, only play certain sections, play specific MPAA (or similar) rated AIC material (e.g., G, PG, PG-13, R, NC-17, X, XXX), play with or without advertisements, play only if content is paid for, only play in certain geographic regions, AIC capturer/creator, AIC source, title, subject matter, bit rate, AIC dimensions, format, individualized or grouped preferences, individual or grouped viewership/sales trends, is related to certain brands/personalities, etc. and the like. While discussed more below, there may be different AIC distribution rule sets based on attributes, including but not limited to, the rules and goals described above. The different variable characteristic rules or goals that drive the selection of the AIC may be weighted in any proportion as deemed appropriate such that AIC component items may be specifically included, excluded, prioritized, or given a probability of being included in a final AIC. Please note the term set is used generically herein and may mean any collection of a given thing (including the null set (an empty set), a singular set (a set with a single component), or multiple set (a set with multiple components, including sets or subsets)). Also, there may be overlap or duplication between goals and rules.

The Promotion Request Engine (102) to an extent is often the start of the process where there is a desire from an entity to create AIC. As described previously this may be any sort of content but in this exemplary embodiment it may be an advertisement for a product that a company wants promoted. As an example, but not a limitation, Coke wants to create and place AIC advertisements that drive general brand promotion as well as specific sales. This AIC advertisement request from the Promotion Request Engine (102) is coordinated with the marketing campaign business rules and goals housed in the Media Content Business Rules and Goals Engine (101) to ensure that any AIC created aligns with the Coke brand presentation rules (e.g., logos, creative treatments, look & feel, marketing messaging, marketing locations, presentation style, etc.) and the marketing plan expense structure.

The Context Engine (103) provides the ability to ingest, analyze, interpret, and communicate the environment that the user was, is, or will be in or also the environment that would be best for any given AIC to appear in. The context may cover a broad variety of characteristics, including but not limited to, location, date, time, rate of movement, other content consumed, other content reacted to, search history, similar user previous experience, audio or visual things detected around the user, or other similar components. It should also be noted that context may also include the identification of the user themselves (the user may be identified by a variety of ways including contextual data or the playout device descriptive data). Furthermore, the term context may even extend to the physical (e.g., hot, tired, thirsty, etc.), psychological (e.g., open influence or suggestion, etc.), or emotional (e.g., anxious, relaxed, etc.) state of the user or those around the user (the general environment they are in (e.g., an exciting sporting event, a somber funeral, a contemplative sermon, a boring meeting, a crowded subway, etc.)). The Context Engine (103) is communicatively coupled to (and may also include) sensors to detect and report upon the user environment. As a part of this process contextual elements that are more relevant to the brand, rules, goals, or user are prioritized. Thus, contextually relevant items are more highly weighted or prioritized to ensure that the user contextual content is meaningful. As an example, but not limitation, it is often the case that a user's mobile phone or a home viewing device (e.g., connected TV, PC, Tablet, etc.) or other devices of a user are contextual detection tools that can be communicatively coupled with the larger AIC system. However, other devices that are not the user's such as, but not limited to, security cameras, weather stations, traffic detection systems, Google maps, GPS/CPS tracking systems, etc. that are capable of sharing information with the AIC system can all be considered devices that provide contextual information. Furthermore, it should be noted that the contextual information devices may capture and share data over periods of time to build larger and stronger predictive models to reflect current and future context more accurately for the user. In the given exemplary embodiment, the Context Engine (103) is able to recognize and communicate that the user is currently traveling in a subway in New York City at 5:30 pm and the temperature is 95 degrees. The Context Engine (103) also recognizes that the user is scrolling on their phone, it is approximately 10 minutes away from the stop they usually get off at and there are 12 places to purchase a Coke between the station and the user's apartment. The system recognizes that this user is a good target for a Coke AIC advertisement given the marketing campaign and the user's context.

The Media Content Business Rules and Goals Engine (101), the Promotion request Engine (102) and the Context Engine (103) may be combined to create the Target Content Framework (104). The Target Content Framework (104) engine establishes the AIC that is needed to achieve the goals most effectively, inexpensively, and efficiently. The Target Content Framework (104) produces the parameters of the AIC to be created and directs an AIC request to the Real Content Library (105) and the AI Content Creation Engine (106), this request articulates the desired AIC and serves as the seed or start of the content creation process - this is the initial AI prompt (that may or may not be in natural language, it may be non-human readable data). This request or prompt may be simple (brief) up to complex (lengthy, highly detailed, with many parameters) and include amongst other aspects, things to include as well as things to exclude from the AIC.

The Real Content Library (105) stores pre-existing content that may serve as a basis for the AI Content Creation Engine (106) or may be directly used in the AIC merged content. This library may be sourced from the internet or any repository of public or private content. The addition of content to the Real Content Library (105) may happen at any given time in real-time, near real-time, continuously, or periodically by a user or another system.

The Real Content Library (105) may help to provide source material for the AI Content Creation Engine (106) based on direction from the Target Content Framework (104) to ensure that AIC is compliant with the rules and goals. The Real Content Library (105) in the given example may include official Coke related images, logos, tag lines, and other brand related materials. Furthermore, it may include images and information related to the user's subway stop and the usual route between the subway stop and the user's apartment, including but not limited to, images of the street, stores, beverage coolers, and the like. The use of specific existing content helps to enable the creation of AIC that is uniquely tailored for this individual user in this specific context. Additionally, it should be remembered that this described example process for creating a tailored Coke AIC ad may happen numerous additional times for numerous other users—but each with their own unique AIC. This and other similar content in the Real Content Library (105) may inform or be incorporated into content that is created by the AI Content Creation Engine (106). Content from the AI Content Creation Engine (106) may be merged with other content from the Real Content Library (105) by the AI Content Merge Engine (107).

The AI Content Merge Engine (107) is the processor that generates the final AIC for user consumption. This process may generate any type or format of content of any duration from a single bit up to endless streams and these may be for a single user or a large number of users. The AI Content Merge engine takes in content from the Real Content Library (105) and the AI Content Creation Engine (106) uses any one or more AI approaches, classical, momentum, or quantum computing approaches to create meaningful content from the input content. It is this AI Content Merge Engine (107) that produces the coherent AIC as a single content package. At this point, the AIC is checked for logical consistency (to ensure that the AI Content Creation Engine (106) did not somehow create content that is inconsistent or incompatible with the Real Content Library (105), the Media Content Business Rules and Goals Engine (101), or is otherwise inappropriate). Additionally, conformity with the promotion request is validated. In the example case the created AIC is checked to make sure, for example, that Coke is spelled correctly, the font that is used is one of the approved fonts, and none of the ad text contains any offensive material.

The AI Content Distribution Rules Engine (108) receives the completed AIC from the AI Content Merge Engine (107). As part of the process, who, what, where, and how the AIC is to be distributed is decided upon. These rules may align with items also included in the Media Content Business Rules and Goals Engine (101), and the user's context, and may cover a variety of things related to the distribution of AIC, including but not limited to sets of, users, platforms, consumption devices, locations, ages, rights restrictions, frequency of distribution, etc. that the AIC is distributed toward. In the given example the Coke related AIC is to be distributed to the user as they approach their stop and prepare to step out into the heat. The AIC focused on cool refreshing Coke may then be shown to the user again on their way to their apartment, reminding the user that it would be great to get a cold Coke from the cooler in the shop that they are about to walk by. In this case the AI Content Distribution Rules Engine (108) takes into consideration the context of mobile phone news feed and the user's physical location as the user is scrolling through right before the user is about to walk by potential Coke points of sale - identifying this time as an effective time to distribute the Coke AIC toward the user.

The AI Content Distribution Server (109) is configured to push (transmit) the AIC toward the AIC consumer content consumption device without a request from the consumer (pushed) or alternatively, to transmit the AIC toward the consumer content consumption device when there is a request from the consumer (pulled). The AI Content Distribution Server (109) may transmit directly toward the end consumer content consumption device or there may be one or more services (servers, sites, platforms, etc.) before the AIC reaches the consumer. In this example case the AI Content Distribution Server (109) follows the direction of the AI Content Distribution Rules Engine (108) pushing the AIC towards the user across a set of communicatively connected IP systems until it reaches the user's consumption device. Alternatively, (in a different exemplary case), a user may request AIC and as long as the request is consistent with the AI Content Distribution Rules Engine (108). Thus, the user may pull the AIC.

The AI Content Distribution Analysis Processor (110) is constructed to keep track of AIC distribution and consumption, including but not limited to, what AIC was distributed, what platforms it was distributed on, what devices was it distributed to, when it was distributed, how many times it was distributed, who it was distributed to, where it was distributed to, in what way was it distributed (including items such as formats, bit rates, complete views, partial views, skips, etc.) and also analyzing the nature of the consumer of the AIC (target consumer, nontarget consumer, bots, etc.), technical delivery information, and the resulting actions (including, but not limited to: clicks, likes, closes, purchases. pull request, push request, etc.). In this example case the AI Content Distribution Analysis Processor (110) captures and reports on where the user was (physically) in relation to Coke points of sale when the Coke AIC was shown, the likelihood that the user actually watched the ad, if the user paused by or went into any of the points of sale on their way to their apartment, etc.

The Results Evaluation Processor (111) provides analysis of the AIC distribution and consumption in light of the rules, goals, and the promotion request. This may also take into consideration other AIC consumption items such as (but not limited to) click throughs to linked brand related sites, likes, shares, sales, etc. The Results Evaluation Processor (111) provides a feedback loop to provide Results for Advertiser (112) which in turn helps to inform the Media Content Business Rules and Goals Engine (101) to provide continued improvements of the process, the AIC, the advertising campaigns, and other elements of interest for the specific brand. Similarly, the Results Evaluation Processor (111) also provides a feedback loop to the Results for Media Content Creator and Platform (113) which in turn helps to inform the Media Content Business Rules and Goals Engine (101). This may be more technical performance data related to the overall process performance and not just the brand specific information. In this example case the user was shown the Coke AIC immediately prior to their walk by Coke points of sale and the user in fact stopped in one of the points of sale and made an Apple Pay purchase of a Coke on their way to their apartment. The AIC, the placement of the AIC, the consumption of the AIC, the purchase of a Coke, and other related data are then looped back into the system to further inform and improve the process such that the goals are more efficiently achieved while being within compliance of the rules. Alternatively, the user may not choose to buy a Coke. This data is also fed back int the system and will further inform the process of creating other AIC including AIC that is targeting other unique users. This process helps to improve the attribution process of matching up marketing activities and consumer actions. Too often there is limited understanding of the impact of specific marketing activities on specific users, this process is able to build causative correlations more successfully between AIC and user activities. Thus, improving the advertising process with more effective, efficient, and inexpensive marketing campaigns.

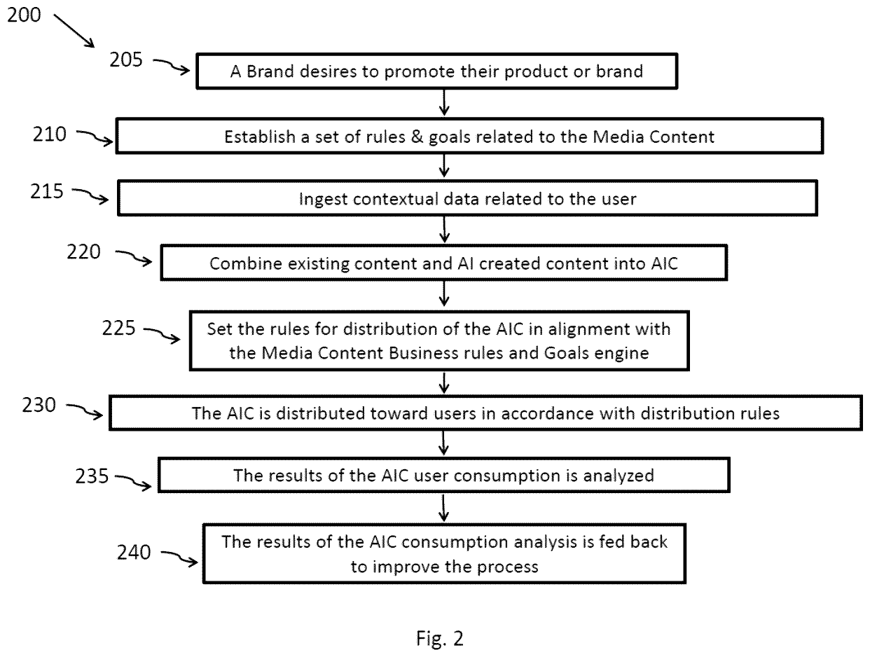

For example, but not limitation, FIG. 2 is a basic exemplary illustration of the AIC personalized contextual content creation method. It should be noted that each of the following steps may be performed systematically and automatically with or without user intervention, or each may also be performed with a user override. Additionally, the rules or goals of this AIC personalized contextual content creation method (200) may be pre-set or may be dynamically adapted in real-time or near real-time (continuously or periodically), and the adaptations may be based on the information that is available at that time, and also as additional information becomes available the rules or goals may be further dynamically (continuously or periodically) adapted. Furthermore, the goals or rules of this method (200) may be updated or adapted periodically or continuously based on pull or push commands internal or external to the process. These changes may be based on either or a combination of user /AI/ML input and will be described in more detail below. Furthermore, the entire process may occur with multiple sets of AIC and the steps may be nested with different sets of AIC being processed at separate times, synchronously or asynchronously. Also, the various steps may occur in the original sequence, in alternative sequences, in parallel, or may even skip steps in various embodiments, especially when the process (or portions of the process) is run multiple times.

FIG. 2 illustrates a flowchart (200) for a method according to an exemplary embodiment. As an example, but not limitation, a brand wants to promote themselves or their products via personalized contextual media content (205). In an exemplary embodiment meant to be illustrative but not limiting in relation to the current invention, Disney wants to provide AIC to a user that is waiting in a lengthy line for the Space Mountain attraction at Disney World. In this example case Disney desired to have AIC that helps to entertain the user while online, promote Disney products, and improve the overall user experience, while adhering to the Disney brand presentation requirements.

The set of rules and goals related to the Media Content are established (210) which include but are not limited to: items that are to be optimally maximized or minimized (the content itself or the results from the content), who the target user is, what the AIC is (and is not), how, when, and where the AIC is delivered to the user, and other related or similar parameters. In the exemplary embodiment it is required that the AIC complies with Disney's brand positioning, is entertaining to the user, and overall improves the user's experience while waiting online for Space Mountain.

With the given method, contextual data related to the user is identified (215). In the example case items, including but not limited to, the physical location (in line for Space Mountain), their rate of movement (very slow), their content consumption activity and device (scrolling through content on their phone), time of day (in the afternoon), weather conditions (in the 90's with 90% humidity). Furthermore, it may be the case that other systems are engaged to add to the contextual data, including but not limited to in this given example, security camera data from the Space Mountain line, ride performance information related to Space Mountain, analytics related to the expected wait time, Disney World user ticket information (adults and children), food and product purchase history at Disney World for the user, user Disney+application subscription or usage information, or similar contextual information is provided to allow for the creation of appropriate AIC that is aligned with the rules and goals—and optimized for that particular user. In this given case the contextual information is aggregated to indicate that the user is in line for Space Mountain, the line will take an estimated one hour, the user is with two children approximately 10 and 12 years old, they regularly watch Disney+ programming, they have been in the park since it opened, they visited Star Wars related attractions, and have been active all day and most likely at this point in the afternoon are a bit tired and hungry, also the 10 year old is most likely less interested in Space Mountain than the 12 year old.

Overall in light of the brand's promotion campaign, the associated rules and goals, and the user's context, existing and newly created AI content is merged via an AI engine to create AIC (220). In this given example embodiment, the AIC that is created and presented to the user is an interactive show and game based on the Disney show Young Jedi Adventures. This AIC show and game is able to be extended from the primary user's phone (the parent) to each of the children's phones. The AIC show and game incorporates current existing content related to the show and the Disney brand and also AI dynamically created content that is able to take into consideration contextual elements of the users'current Disney World experience. For example, in addition to Young Jedi Adventures content (that may include Disney World attraction related content) they can be given quizzes about things they have seen at Star Wars attractions at Disney World so far, find hidden objects that are visible from here they are in the line, gain game points, and qualify for prizes. The AIC continues to be produced and distributed in parallel to their progress in the line such that the game concludes just before they are to get on the Space Mountain ride.

The AIC content is to be distributed in accordance with the rules and goals (225). In this example case, before the AIC show and game content is extended to the children the parent's consent is needed, the content needs to be appropriate for the users, and the content needs to be consistent with the Disney brand. Furthermore, the distribution is to be contextually relevant for the user of the content. The AIC is then distributed toward one or more users (230) content consumption devices via one or more platforms (in this case since the users can be on the Disney Wi-Fi—the content can be in extremely high quality without much concern about lag, and precise user location can be determined) in accordance with distribution rules. In the example case, the Young Jedi Warriors interactive AIC show, and game is targeted to specific users in a specific context where it is meaningful for those users and overall creates a better experience. Furthermore, for example, the process may be dynamic in that if there are delays in the line the AIC show and game extend the story and add additional levels to the game. If there are bigger issues and additional delays the users may be given, via the AIC, credits for Fast Passes to other rides or coupons for a free ice cream in the gift shop after the Space Mountain ride.

The quality and quantity of the AIC consumption is analyzed (235). In this example, elements such as engagement with the AIC show and game may be measured (did the kids use it for most of their time online), also other monitoring systems may be employed (does the security camera show that the children fidgeted less and seem happier with the AIC show and game - not minding the wait on the line). Also, surveying may be done of the users to provide feedback. These results may then be shared with the AIC creation system, the AIC distribution platforms, or the brand to further improve AIC and AIC promotions going forward (240).

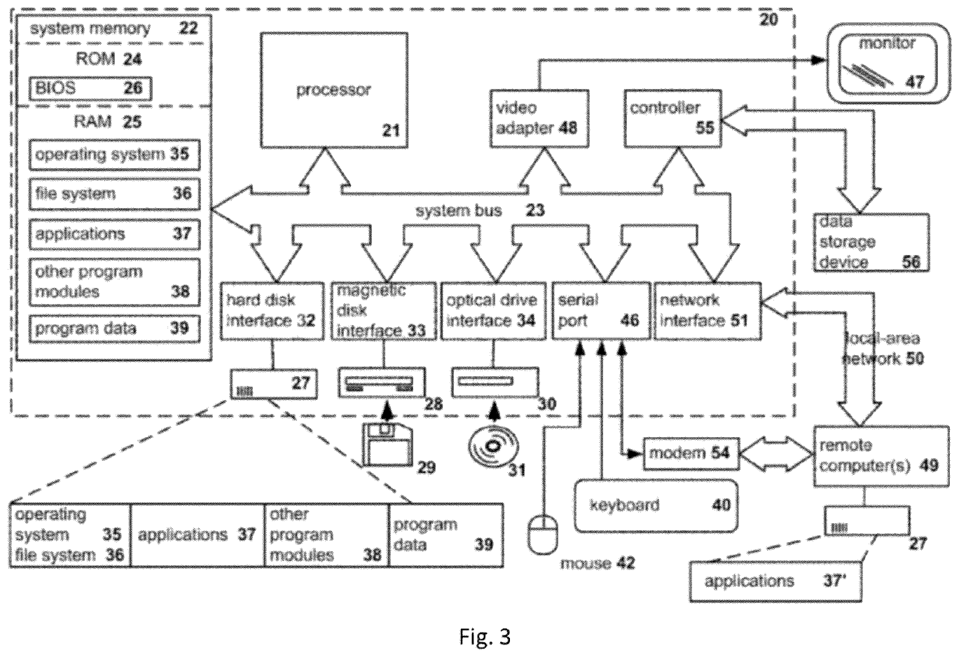

FIG. 3 illustrates an example of a general-purpose (classical or traditional) computer system (which may be a personal computer, a server, or a plurality of personal computers and servers) that can support AI processing, on which the disclosed system and method can be implemented according to an example aspect. It should be appreciated that the detailed general purpose computer system can correspond to the GCMS (100) described above with respect to FIG. 1 to implement the algorithms described above. This general-purpose computer system (processor and storage) may exist in a single physical location, with a broadly distributed structure, virtually as a set or subset of larger computing systems (e.g., in the computing “cloud”), or a combination of any of these. Please note this is provided as an example not a limitation and the example embodiment may also use a quantum computing system in place of the general-purpose computer, or a quantum computer could be used in conjunction with the general-purpose computer. This combination may be performed in parallel, or series, or both, and similarly there may be multiple general-purpose computers or quantum computers used.

As shown, the computer system 20 includes a central processing unit 21, a system memory 22 and a system bus 23 connecting the various system components, including the memory associated with the central processing unit 21. The central processing unit 21 can be provided to execute software code (or modules) for the one or more set of rules discussed above which can be stored and updated on the system memory 22. Additionally, the central processing unit 21 may be capable of executing traditional computing logic, quantum computing, or a combination of both. Furthermore, the system bus 23 is realized like any bus structure known from the prior art, including in turn a bus memory or bus memory controller, a peripheral bus, and a local bus, which is able to interact with any other bus architecture. The system memory includes read only memory (ROM) 24 and random-access memory (RAM) 25. The basic input/output system (BIOS) 26 includes the basic procedures ensuring the transfer of information between elements of the personal computer 20, such as those at the time of loading the operating system with the use of the ROM 24.

As noted above, the rules described above can be implemented as modules according to an exemplary aspect. As used herein, the term “module” refers to a real-world device, component, or arrangement of components implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module can also be implemented as a combination of the two, with certain functions facilitated by hardware alone, and other functions facilitated by a combination of hardware and software. In certain implementations, at least a portion, and in some cases, all, of a module can be executed on the processor of a general-purpose computer. Accordingly, each module can be realized in a variety of suitable configurations and should not be limited to any example implementation exemplified herein.

The personal computer 20, in turn, includes a hard disk 27 for reading and writing of data, a magnetic disk drive 28 for reading and writing on removable magnetic disks 29 and an optical drive 30 for reading and writing on removable optical disks 31, such as CD-ROM, DVDROM and other optical information media. The hard disk 27, the magnetic disk drive 28, and the optical drive 30 are connected to the system bus 23 across the hard disk interface 32, the magnetic disk interface 33 and the optical drive interface 34, respectively. The drives and the corresponding computer information media are power-independent modules for storage of computer instructions, data structures, program modules and other data of the personal computer 20. Moreover, it is noted that any of the storage mechanisms (including data storage device 56, which may be amongst other things, physical hardware, CDNs, or the “cloud”) can serve as the storage of the media Content, including the Available Content Library (111) described above, according to an exemplary aspect as would be appreciated to one skilled in the art.

The present disclosure provides the implementation of a system that uses a hard disk 27, a removable magnetic disk 29 or a removable optical disk 31, but it should be understood that it is possible to employ other types of computer information media 56 which are able to store data in a form readable by a computer (solid state drives, flash memory cards, digital disks, random access memory (RAM) and so on, locally or remotely), which are connected to the system bus 23 via the controller 55.

The computer 20 has a file system 36, where the recorded operating system 35 is kept, and also additional program applications 37, other program modules 38 and program data 39. The user is able to enter commands and information into the personal computer 20 by using input devices (keyboard 40, mouse 42). Other input devices (not shown) can be used: microphone, joystick, game controller, scanner, other computer systems, and so on. Such input devices usually plug into the computer system 20 through a serial port 46, which in turn is connected to the system bus, but they can be connected in other ways, for example, with the aid of a parallel port, a game port, a universal serial bus (USB), a wired network connection, or wireless data transfer protocol. A monitor 47 or other type of display device is also connected to the system bus 23 across an interface, such as a video adapter 48. In addition to the monitor 47, the personal computer can be equipped with other peripheral output devices (not shown), such as loudspeakers, a printer, and so on.

The personal computer 20 is able to operate within a network environment, using a network connection to one or more remote computers 49, which can correspond to the remote viewing devices, i.e., the IP connected device (e.g., a smartphone, tablet, personal computer, laptop, media display device, or the like). Other devices can also be present in the computer network, such as routers, network stations, peer devices or other network nodes.

Network connections 50 can form a local-area computer network (LAN), such as a wired or wireless network, and a wide-area computer network (WAN). Such networks are used in corporate computer networks and internal company networks, and they generally have access to the Internet. In LAN or WAN networks, the personal computer 20 is connected to the network 50 across a network adapter or network interface 51. When networks are used, the personal computer 20 can employ a modem 54 or other modules for providing communications with a wide-area computer network such as the Internet or the cloud. The modem 54, which is an internal or external device, is connected to the system bus 23 by a serial port 46. It should be noted that the network connections are only examples and need not depict the exact configuration of the network, i.e., in reality there are other ways of establishing a connection of one computer to another by technical communication modules, such as Bluetooth.

In various aspects, the systems and methods described herein may be implemented in hardware, software, firmware, or any combination thereof. If implemented in software, the methods may be stored as one or more instructions or code on a non-transitory computer readable medium. Computer-readable medium includes data storage. By way of example, and not limitation, such computer-readable medium can comprise RAM, ROM, EEPROM, CDROM, Flash memory or other types of electric, magnetic, or optical storage medium, or any other medium that can be used to carry or store desired program code in the form of instructions or data structures and that can be accessed by a processor of a general-purpose computer.

In the interest of clarity, not all of the routine features of the aspects are disclosed herein. It will be appreciated that in the development of any actual implementation of the present disclosure, numerous implementation-specific decisions must be made in order to achieve the developer's specific goals, and that these specific goals will vary for different implementations and different developers. It will be appreciated that such a development effort might be complex and time-consuming but would nevertheless be a routine undertaking of engineering for those of ordinary skill in the art having the benefit of this disclosure.

It is noted that terms “compromises,” “comprising,” “includes,” “including,” “has,” “having” or any other variation thereof, are intended to cover a non-exclusive inclusion. For example, a process, system, method, article, or apparatus that comprises a list of elements is not necessarily limited to only those elements but may include other elements not expressly listed or inherent to such processes, systems methods, articles, or apparatus. Further, unless expressly stated to the contrary, “or” refers to an inclusive or and not to an exclusive or. For example, a condition A or B is satisfied by any one of the following: A is true (or present), and B is false (or not present), A is false (or not present), and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise (similarly and alternatively the plural may mean one or at least one unless it is obvious that it is meant otherwise).

Furthermore, as used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Upon reading this disclosure, those of skill in the art will appreciate additional alternative systematic and functional designs. Thus, while particular embodiments and applications have been illustrated and described herein, it is to be understood that the disclosed embodiments are not limited to the precise construction and components disclosed herein. Various modifications, changes, and variations, which will be apparent to those skilled in the art, may be made in the arrangement, operation, and details of the system and method disclosed herein without departing from the spirit and scope defined in the claims.

Furthermore, it is to be understood that the phraseology or terminology used herein is for the purpose of description and not of restriction, such that the terminology or phraseology of the present specification is to be interpreted by those skilled in the art in light of the teachings and guidance presented herein, in combination with the knowledge of the skilled in the relevant arts. Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A system for artificial intelligence powered creation of personalized contextual content, the system comprising:
at least one processor communicatively coupled to at least one database, the at least one processor configured to execute software instructions stored on a non-transitory computer readable medium to operate:
(a) a Promotion Request Engine configured to receive at least one promotion or content request from an entity desiring to create personalized contextual content, and to coordinate the at least one promotion or content request with at least one set of brand presentation rules and marketing objectives;
(b) a Media Content Business Rules and Goals Engine communicatively coupled to the Promotion Request Engine, configured to establish and dynamically adapt at least one set of rules or goals related to at least one set of content to be created, wherein the at least one set of rules or goals governs at least one of:
the nature of the content, the target content user, platform or device requirements, intellectual property restrictions, or performance maximization objectives;
(c) a Context Engine communicatively coupled to at least one sensor, configured to ingest, analyze, interpret, and communicate at least one set of context data describing at least one of the environment the content user was, is, or is expected to be in, the content user's identity, the content user's physical or emotional state, or the content user's device and behavioral history;
(d) a Real Content Library configured to store and provide access to pre-existing content that serves as at least one basis for generating personalized contextual content;
(e) a Target Content Framework configured to synthesize outputs of the Promotion Request Engine, the Media Content Business Rules and Goals Engine, and the Context Engine to establish parameters for at least one set of content to be created, and to generate at least one prompt directing the Real Content Library and an AI Content Creation Engine to produce content aligned with the at least one set of rules or goals and the at least one set of context data;
(f) an AI Content Creation Engine configured to generate at least one set of AI-created content based on the at least one prompt received from the Target Content Framework;
(g) an AI Content Merge Engine communicatively coupled to the Real Content Library and the AI Content Creation Engine, configured to:
(i) combine content from the Real Content Library and the at least one set of AI-created content using at least one artificial intelligence approach to generate at least one set of user personalized content as a single content package; and
(ii) verify logical consistency of the at least one set of user personalized content against the Real Content Library and the at least one set of rules or goals to ensure the at least one set of user personalized content is internally coherent and compliant with the at least one promotion or content request;
(h) an AI Content Distribution Rules Engine communicatively coupled to the AI Content Merge Engine, configured to determine at least one set of distribution rules governing who, what, where, and how the at least one set of user personalized content is to be transmitted toward at least one content consumption device of the at least one content user;
(i) an AI Content Distribution Server configured to transmit the at least one set of user personalized content toward the at least one content consumption device in accordance with the at least one set of distribution rules, using a two-way communication channel that permits collection of consumption or use data from the at least one content consumption device;
(j) an AI Content Distribution Analysis Processor configured to analyze at least one set of use data collected via the two-way communication channel, wherein the at least one set of use data includes:
(i) at least one of content consumption data comprising views, completion rates, skip data, or format information, or resulting consumer actions; and
(ii) physiological inputs from the at least one content user comprising at least one of eye tracking movement, physiological responses including respiration, heart rate, pupil changes, or skin galvanic changes, or neural feedback; and
(k) a Results Evaluation Processor configured to evaluate the at least one set of use data in light of the at least one set of rules or goals, and to provide a closed feedback loop to the Media Content Business Rules and Goals Engine wherein the physiological inputs collected by the AI Content Distribution Analysis Processor are used by a machine learning engine to dynamically learn and adjust at least one of: rules, goals, or content creation parameters, thereby dynamically adapting at least one of the rules, goals, or content creation process of the system for subsequent generation of user personalized content.

2. The system of claim 1, wherein the at least one set of user personalized content comprises at least one of: video, audio, images, text, or metadata.

3. The system of claim 1, wherein the at least one prompt generated by the Target Content Framework includes at least one of: the content user's identity, the content user's physical location, the time of day, the content user's emotional or physiological state, or specific brand elements required to be included in or excluded from the at least one set of user personalized content.

4. The system of claim 1, wherein the machine learning engine of element (k) is further configured to modify the at least one set of user personalized content as it is being consumed by the at least one content user based on the physiological inputs collected in real-time or near real-time via the two-way communication channel, such that portions of the at least one set of user personalized content that have not yet been delivered to the content consumption device are dynamically altered based on the collected use data.

5. The system of claim 1, wherein the AI Content Merge Engine is further configured to aggregate content from multiple perspectives and generate at least one set of user personalized content comprising holographic, Virtual Reality, Augmented Reality, or Mixed Reality content, and wherein the at least one set of distribution rules governs playout of the at least one set of user personalized content on at least one head-mounted or spatial display device.

6. The system of claim 1, wherein the Media Content Business Rules and Goals Engine is configured to dynamically adapt the at least one set of rules or goals in real-time or near real-time based on at least one of: updated context data received from the Context Engine, performance data received from the Results Evaluation Processor, or external data comprising changes in laws, regulations, licenses, news events, or product sales trends.

7. The system of claim 1, wherein the logical consistency verification performed by the AI Content Merge Engine comprises validating that the at least one set of user personalized content conforms to brand identity elements specified in the Promotion Request Engine, does not contain content that violates the at least one set of rules or goals established by the Media Content Business Rules and Goals Engine, and is free of content that is inconsistent with source material in the Real Content Library.

8. The system of claim 1, wherein the system is configured to simultaneously generate and distribute a plurality of distinct sets of user personalized content to a plurality of content users, wherein each distinct set of user personalized content is independently personalized based on the respective content user's at least one set of context data, and wherein at least two of the plurality of distinct sets of user personalized content are configured to interact with each other in real-time or near real-time such that use data or content modifications associated with a first set of user personalized content dynamically influence content generation for at least one other distinct set of user personalized content.

9. The system of claim 1, wherein the AI Content Creation Engine is configured to generate at least one set of user personalized content having no predetermined storyline or ending, such that the narrative or content structure of the at least one set of user personalized content develops over time based on the closed feedback loop of the Results Evaluation Processor and the use data collected by the AI Content Distribution Analysis Processor.

10. The system of claim 1, wherein the at least one set of user personalized content comprises at least one of: entertainment, education, training, security analysis, military strategy, emergency response, or medical data content.

11. A method for artificial intelligence powered creation of personalized contextual content, the method comprising:
utilizing at least one processor communicatively coupled to at least one database, the at least one processor executing software instructions stored on a non-transitory computer readable medium to perform:
(a) receiving, via a Promotion Request Engine, at least one promotion or content request from an entity desiring to create personalized contextual content, and coordinating the at least one promotion or content request with at least one set of brand presentation rules and marketing objectives;
(b) establishing and dynamically adapting, via a Media Content Business Rules and Goals Engine, at least one set of rules or goals related to at least one set of content to be created, wherein the at least one set of rules or goals governs at least one of: the nature of the content, the target content user, platform or device requirements, intellectual property restrictions, or performance maximization objectives;
(c) ingesting, analyzing, and communicating, via a Context Engine communicatively coupled to at least one sensor, at least one set of context data describing at least one of the environment the content user was, is, or is expected to be in, the content user's identity, the content user's physical or emotional state, or the content user's device and behavioral history;
(d) storing and providing access to pre-existing content via a Real Content Library that serves as at least one basis for generating personalized contextual content;
(e) synthesizing, via a Target Content Framework, outputs of the Promotion Request Engine, the Media Content Business Rules and Goals Engine, and the Context Engine to establish parameters for at least one set of content to be created, and generating at least one prompt directing the Real Content Library and an AI Content Creation Engine to produce content aligned with the at least one set of rules or goals and the at least one set of context data;
(f) generating, via an AI Content Creation Engine, at least one set of AI-created content based on the at least one prompt received from the Target Content Framework;
(g) combining, via an AI Content Merge Engine, content from the Real Content Library and the at least one set of AI-created content using at least one artificial intelligence approach to generate at least one set of user personalized content as a single content package; and verifying logical consistency of the at least one set of user personalized content against the Real Content Library and the at least one set of rules or goals to ensure the at least one set of user personalized content is internally coherent and compliant with the at least one promotion or content request;
(h) determining, via an AI Content Distribution Rules Engine, at least one set of distribution rules governing who, what, where, and how the at least one set of user personalized content is to be transmitted toward at least one content consumption device of the at least one content user;
(i) transmitting, via an AI Content Distribution Server, the at least one set of user personalized content toward the at least one content consumption device in accordance with the at least one set of distribution rules, using a two-way communication channel that permits collection of consumption or use data from the at least one content consumption device;
(j) analyzing, via an AI Content Distribution Analysis Processor, at least one set of use data collected via the two-way communication channel, wherein the at least one set of use data includes:
(i) at least one of content consumption data comprising views, completion rates, skip data, or format information, or resulting consumer actions; and
(ii) physiological inputs from the at least one content user comprising at least one of eye tracking movement, physiological responses including respiration, heart rate, pupil changes, or skin galvanic changes, or neural feedback; and
(k) evaluating, via a Results Evaluation Processor, the at least one set of use data in light of the at least one set of rules or goals, and providing a closed feedback loop to the Media Content Business Rules and Goals Engine wherein the physiological inputs collected by the AI Content Distribution Analysis Processor are used by a machine learning engine to dynamically learn and adjust at least one of: rules, goals, or content creation parameters, thereby dynamically adapting at least one of the rules, goals, or content creation process of the system for subsequent generation of user personalized content.

12. The method of claim 11, wherein the at least one set of user personalized content comprises at least one of: video, audio, images, text, or metadata.

13. The method of claim 11, wherein the at least one prompt generated by the Target Content Framework includes at least one of: the content user's identity, the content user's physical location, the time of day, the content user's emotional or physiological state, or specific brand elements required to be included in or excluded from the at least one set of user personalized content.

14. The method of claim 11, wherein the machine learning engine of element (k) is further configured to modify the at least one set of user personalized content as it is being consumed by the at least one content user based on the physiological inputs collected in real-time or near real-time via the two-way communication channel, such that portions of the at least one set of user personalized content that have not yet been delivered to the content consumption device are dynamically altered based on the collected use data.

15. The method of claim 11, wherein the AI Content Merge Engine is further configured to aggregate content from multiple perspectives and generate at least one set of user personalized content comprising holographic, Virtual Reality, Augmented Reality, or Mixed Reality content, and wherein the at least one set of distribution rules governs playout of the at least one set of user personalized content on at least one head-mounted or spatial display device.

16. The method of claim 11, wherein the at least one set of rules or goals is dynamically adapted in real-time or near real-time based on at least one of: updated context data, performance data from the Results Evaluation Processor, or external data comprising changes in laws, regulations, licenses, news events, or product sales trends.

17. The method of claim 11, wherein verifying logical consistency further comprises validating that the at least one set of user personalized content conforms to brand identity elements specified in the Promotion Request Engine, does not contain content that violates the at least one set of rules or goals, and is free of content that is inconsistent with source material in the Real Content Library.

18. The method of claim 11, wherein the method further comprises simultaneously generating and distributing a plurality of distinct sets of user personalized content to a plurality of content users, wherein each distinct set of user personalized content is independently personalized based on the respective content user's at least one set of context data, and wherein at least two of the plurality of distinct sets of user personalized content are configured to interact with each other in real-time or near real-time such that use data or content modifications associated with a first set of user personalized content dynamically influence content generation for at least one other distinct set of user personalized content.

19. The method of claim 11, wherein the AI Content Creation Engine generates at least one set of user personalized content having no predetermined storyline or ending, such that the narrative or content structure develops over time based on the closed feedback loop and the use data collected by the AI Content Distribution Analysis Processor.

20. The method of claim 11, wherein the at least one set of user personalized content comprises at least one of: entertainment, education, training, security analysis, military strategy, emergency response, or medical data content.
